(19) United States
(12) Patent Application Publication
(10) Pub. No.: US 2009/0060594 A1
(43) Pub. Date: Mar. 5, 2009

(54) DEVELOPING DEVICE

(75) Inventors: Teruhiko INADA, Hyogo (JP); Tetsuo Tanda, Osaka (JP); Tetsuro Tomoe, Nara (JP); Shinichi Uchida, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 12/199,383

(22) Filed: Aug. 27, 2008

(30) Foreign Application Priority Data
Aug. 31, 2007 (JP) 2007-226710

(51) Int. Cl. G03G 15/08

(52) U.S. Cl. 399/284

(57) ABSTRACT

A developing device includes a toner container, a developer carrier, end-portion sealing parts, and a regulating member. The toner container is disposed to be adjacent to the image carrier, and has an opening. The developer carrier is rotatably supported by the toner container so that a part of the developer carrier is exposed to the outside from the opening, and provides the image carrier with toner. The end-portion sealing parts are disposed in the axial end portions of the opening, and prevent toner leaking from the toner container. The regulating member regulates the amount of toner on the developer carrier while the tip side contacts the surface of the developer carrier, and tip edges of axial end portions of the regulating member contact the surface of the developer carrier while the axial end portions are pressed to the surface of the developer carrier by the end-portion sealing parts.

### CROSS-REFERENCE TO RELATED APPLICATIONS

This application claims priority to Japanese Patent Application No. 2007-226710 filed on Aug. 31, 2007, the entirety of which is hereby incorporated by reference in its entirety.

### BACKGROUND OF THE INVENTION

1. Field of the Invention

The present invention relates to a developing device, especially a developing device configured to be used in an image forming device.

2. Background Information

A developing device configured to be used in an image forming device is a device for forming a toner image on the surface of an image carrier (e.g., a photosensitive drum and a photosensitive belt), and includes a toner container that has an opening in a part opposed to the image carrier and contains toner in its interior, and a developing roller rotatably disposed in the opening of the toner container. Also, as described in Japan Patent Application Publication No. JP-A-2000-105501, a toner container is provided with a regulating member for regulating thickness of a toner layer formed on the surface of a developing roller, end-portion sealing parts disposed in the axial end portions of the developing roller, and a sheet member disposed to be opposed to the regulating member.

In this type of developing device, toner contained in the toner container is firstly supplied to the surface of the developing roller. Then, the thickness of the toner layer formed on the surface of the developing roller is regulated to be a predetermined thickness by the regulating member. Then, toner is supplied to the image carrier from the developing roller. Also, the regulating member, the end-portion sealing parts, and the sheet member prevent toner from leaking to the outside through the opening of the toner container.

Here, it is necessary to form a toner layer with the predetermined thickness on the surface of the developing roller for the purpose of supplying the desired amount of toner to the image carrier from the developing roller. In addition, as illustrated in FIG. 8A, it is necessary to produce a gap “g” between a tip edge 100a of a regulating member 100 and the surface of a developing roller 101 for the purpose of forming a toner layer with the predetermined thickness on the surface of the developing roller. As illustrated in FIG. 8B, if the both end portions of the regulating member 100 are covered with end-portion sealing parts 102 while the gap g is kept formed, another gap g is also formed between the developing roller 101 and the end-portion sealing part 102. In this case, toner contained in the toner container may leak to the outside through the gap g.

In view of the above, it will be apparent to those skilled in the art from this disclosure that there exists a need for an improved developing device. This invention addresses this need in the art as well as other needs, which will become apparent to those skilled in the art from this disclosure.

### SUMMARY OF THE INVENTION

An object of the present invention is to prevent toner from leaking outside by making it difficult to produce a gap between an end-portion sealing part and a developing roller.

A developing device according to the present invention is a developing device for supplying an image carrier with toner, and includes a toner container, a developer carrier, end-portion sealing parts, and a regulating member. The toner container is disposed to be adjacent to the image carrier, has an opening on a side opposed to the image carrier, and is configured to contain toner in its interior. The developer carrier is rotatably supported by the toner container so that a part of the developer carrier is exposed to the outside from the opening formed in the toner container, and is configured to provide the image carrier with toner. The end-portion sealing parts are disposed in the axial end portions of the opening formed in the toner container, and are configured to prevent toner leaking from the toner container. The regulating member is provided to regulate the amount of toner on the developer carrier while the tip side makes contact with the surface of the developer carrier, and tip edges of axial end portions of the regulating member make contact with the surface of the developer carrier while the axial end portions are pressed to the surface of the developer carrier by the end-portion sealing parts.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic view of a color printer in accordance with a preferred embodiment of the present invention;

FIG. 2 is a detailed cross-sectional view of a toner supplying device of the color printer;

FIG. 3 is a cross-sectional view of a developing unit of the color printer;

FIG. 4 is a view of a diagram illustrating a developing roller and a regulating member of the developing unit;

FIG. 5A is a lateral view of the developing roller and the regulating member;

FIG. 5B is a lateral view illustrating the relation between the developing roller and end portions of the regulating member before the end-portion sealing parts are attached;

FIG. 5C is a lateral view illustrating the relation between the developing roller and the end portions of the regulating member before end-portion sealing parts are attached;

FIG. 6 is a view of a diagram illustrating a regulating member in accordance with another preferred embodiment;

FIG. 7 is a cross-sectional view of the developing roller and the regulating member; and

FIGS. 8A and 8B includes enlarged lateral views of a conventional regulating member and a conventional developing roller.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Configuration

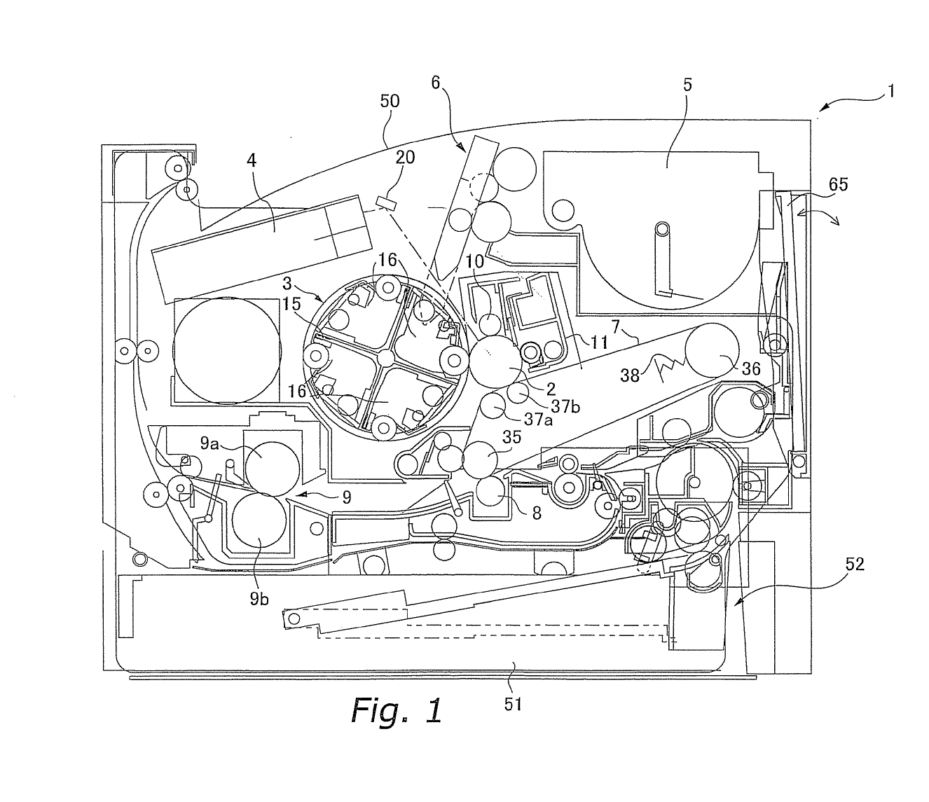

FIG. 1 is a cross-sectional view illustrating a color printer 1 as a color image forming device in accordance with a preferred embodiment of the present invention. Note that FIG. 1 is a schematic view illustrating the arrangement of elements forming the color printer 1, and detailed illustration of the elements is herein omitted.

The color printer 1 is preferably connected to a computer or the like (not illustrated in the figure), and is a device that is configured to print a color image on a sheet of paper based on the image information transmitted from the computer or the like. The color printer 1 includes a photosensitive drum (image carrier) 2, a rotary developing device 3, a laser unit 4, a toner containing part 5, a plurality of toner supplying devices 6, an intermediate transfer belt 7, a secondary transfer roller (transfer part) 8, and a fixing device 9.

The photosensitive drum 2 is configured to have an electrostatic latent image formed on its surface, and is rotatably disposed approximately in the center of the color printer 1. An electric-charging roller 10 is configured to charge uniformly and electrically the surface of the photosensitive drum 2, and is disposed above the photosensitive drum 2. In addition, a drum cleaning device 11 is configured to clean residual toner and attachments on the surface of the photosensitive drum 2, and is disposed lateral to the photosensitive drum 2.

The rotary developing device 3 is configured to develop the electrostatic latent image formed on the surface of the photosensitive drum 2 with toners having a variety of colors. The rotary developing device 3 is disposed to be adjacent to the photosensitive drum 2 while its center is positioned approximately or exactly at the same height position as the center of the photosensitive drum 2. The rotary developing device 3 includes a rotary frame 15 and four developing units 16. Each of the developing units 16 is disposed to correspond to each of four color toners and is supported by the rotary frame 15. The rotary frame 15 is formed in a cylindrical shape and is configured to rotate around an axis in parallel to the rotational axis of the photosensitive drum 2. The rotary frame 15 is configured to be rotated by a driving mechanism including a motor, a gear, or the like (not illustrated in the figure). Also, the rotary frame 15 has four compartments which are formed by circumferentially quartering the rotary frame 15 with partition frames radially extending from the center of the rotational shaft. The developing units 16 are disposed in the compartments, respectively, and each of the developing units 16 corresponds to each of four toner colors (i.e., yellow, cyan, magenta, and black). The developing units 16 will be explained in detail in the following paragraphs.

The laser unit 4 is configured to perform scanning and exposure with respect to the photosensitive drum 2 based on the image information transmitted from an external computer or the like. As illustrated in FIG. 1, the laser unit 4 is disposed above the photosensitive drum 2, and is also disposed on the left of the rotational axis of the rotary developing device 3. Note that elements in the interior of the laser unit 4 are almost the same as the elements in the interior of the conventional laser unit. Specifically, the laser unit 4 includes a laser light, a polygon mirror, a polygon mirror driving motor, or the like. In addition, a reflection mirror 20 is disposed ahead of the laser light path of the laser unit 4. Accordingly, as illustrated with the dashed line in FIG. 1, the laser light emitted from the laser unit 4 is configured to be reflected by the reflection mirror 20, pass the space above the rotary developing device 3, and be irradiated on the surface of the photosensitive drum 2.

The toner containing part 5 is configured and arranged to contain toner to be provided for each of the developing units 16 in the rotary developing device 3. The toner containing part 5 is disposed above the photosensitive drum 2 and is also disposed on the side opposite to the laser unit 4 (i.e., right side in FIG. 1). The toner containing part 5 includes four containing parts, each of which contains each of four color toners (i.e., yellow, cyan, magenta, and black toners) arranged in the horizontal direction (i.e., in the vertical direction with respect to the drawing of FIG. 1). Also, the toner containing part 5 is configured to be allowed to extend or to be taken out from the color printer in the rightward direction in FIG. 1.

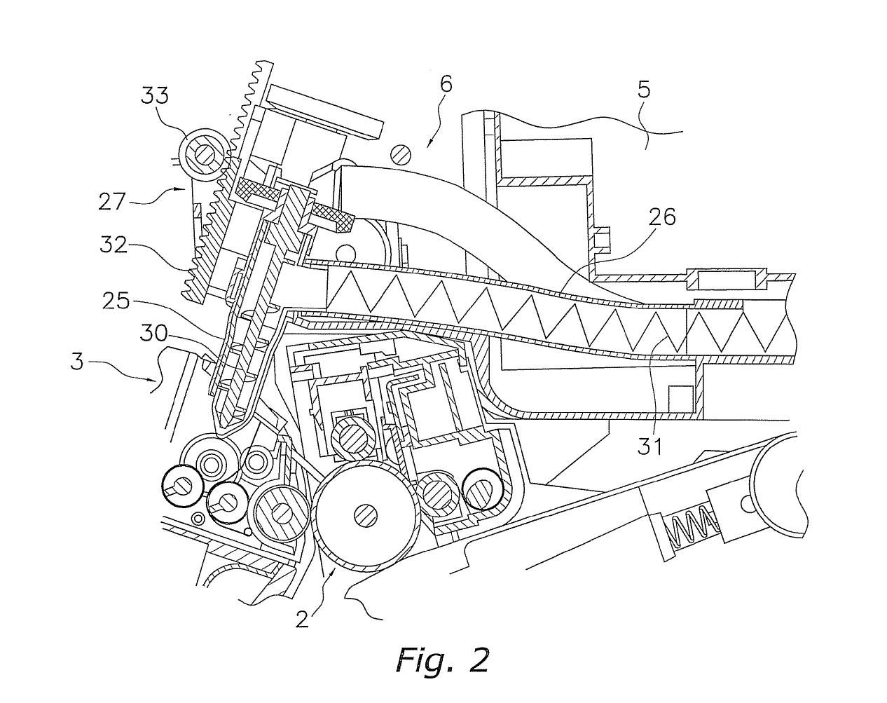

The toner supplying devices 6 are configured to supply four color toners contained in the toner containing part 5 to the corresponding developing units 16, respectively. The toner supplying devices 6 are disposed between the laser unit 4 and the toner containing part 5 above the photosensitive drum 2. As illustrated in FIG. 2, which is an enlarged view of the main elements in FIG. 1, each of the toner supplying devices 6 includes a toner supply pipe 25, a transporting pipe 26, and a driving mechanism 27. Here, the toner supply pipe 25 is configured to move up and down. The transporting pipe 26 connects a part of the toner containing part 5, which contains each of four color toners, with the corresponding toner supply pipe 25. The driving mechanism 27 is configured to move the toner supply pipe 25 up and down.

The toner supply pipe 25 is formed to be elongated in the up-and-down direction. Its upper end is tilted toward the right side in FIG. 1, and its lower end is tilted toward the left side in FIG. 1. The tip of the toner supply pipe 25 is formed in a tapered shape. Accordingly, when the toner supply pipe 25 moves downward, its tip is allowed to enter into the interior of the developing unit 16 through a slit formed in the toner supply part of the developing unit 16. Also, as seen in FIG. 2, a spiral member 30 for transporting toner is rotatably provided in the interior of the toner supply pipes 25.

The transporting pipe 26 is a flexible pipe, and is accordingly capable of moving in conjunction with the up-and-down movement of the toner supply pipe 25. In addition, a coil spring 31 is disposed in its interior. The coil spring 31 is rotated by a driving mechanism (not illustrated in the figure), and toner is accordingly transported toward the toner supply pipe 25 via the interior of the transporting pipe 26.

The driving mechanism 27 includes a rack 32 and a pinion gear 33 on the outer peripheral part of the toner supply pipes 25. The rack 32 is disposed along the axial direction of the pipe, and the pinion gear 33 meshes with the rack 32. The pinion gear 33 is rotatably supported by the frame of the device, and is configured to be driven by a motor or the like (not illustrated in the figure). Also, the toner supply pipe 25 is allowed to be located in an upper retracted position and a lower supply position in which its tip enters the interior of the developing unit 16 by way of the driving mechanism 27.

Referring now to FIG. 1, the intermediate transfer belt 7 is configured such that toner images with the variety of colors formed on the surface of the photosensitive drum 2 are sequentially transferred thereto. The intermediate transfer belt 7 is disposed below the photosensitive drum 2 and the toner containing part 5. The intermediate transfer belt 7 is stretched between a driving roller 35 and a driven roller 36. The driven roller 36 is biased to the direction separated away from the driving roller 35 by a spring 38. Also, a part of the intermediate transfer belt 7 opposed to the photosensitive drum 2 is configured to make contact with the photosensitive drum 2 by way of a pair of primary transfer rollers 37a and 37b.

The secondary transfer roller 8 is configured to transfer the image transferred to the intermediate transfer belt 7 to a sheet of paper that is transported thereto. The secondary transfer roller 8 is disposed below the driving roller 35 so as to be opposed to the driving roller 35. Also, for the purpose of transferring the image onto the sheet of paper, a bias voltage is applied to the secondary transfer roller 8 by way of a voltage applying means (not illustrated in the figure).

The fixing device 9 is configured to melt and to fix the toner transferred onto the sheet of paper. The fixing device 9 is disposed below the rotary developing device 3 on the rear side of the device. The fixing device 9 includes a heating roller 9a in which a heater is incorporated, and a pressure roller 9b to be press-contacted to the heating roller 9a. The fixing device 9 transports a sheet of paper while interposing the sheet of paper between the heating roller 9a and pressure roller 9b.

In the printer 1, a discharge part 50 is formed on the upper surface of the device, that is, above the laser unit 4, the toner supplying device 6, and the toner containing part 5. The discharge part 50 is a part for disposing a sheet of paper onto which an image is formed. Also, a paper feeding cassette 52 is disposed on the bottom part of the device. Furthermore, a paper feeding tray 65 is disposed below the toner containing part 5 and above the paper feeding cassette 52 so as to form a front-side sidewall of the device. The lower end of the paper feeding tray 65 is configured to move rotationally (i.e., configured to be opened/closed). On the other hand, its upper end is configured to be tilted toward the right side in FIG. 1. When the paper feeding tray 65 is opened in this way, it is possible to dispose a sheet of paper on the paper feeding tray 65 and to feed the sheet of paper to the interior of the device.

### Configuration of Developing Unit

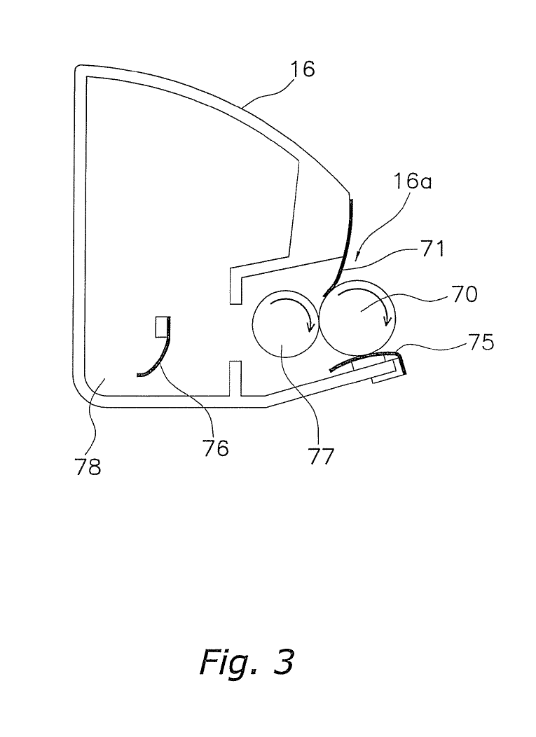

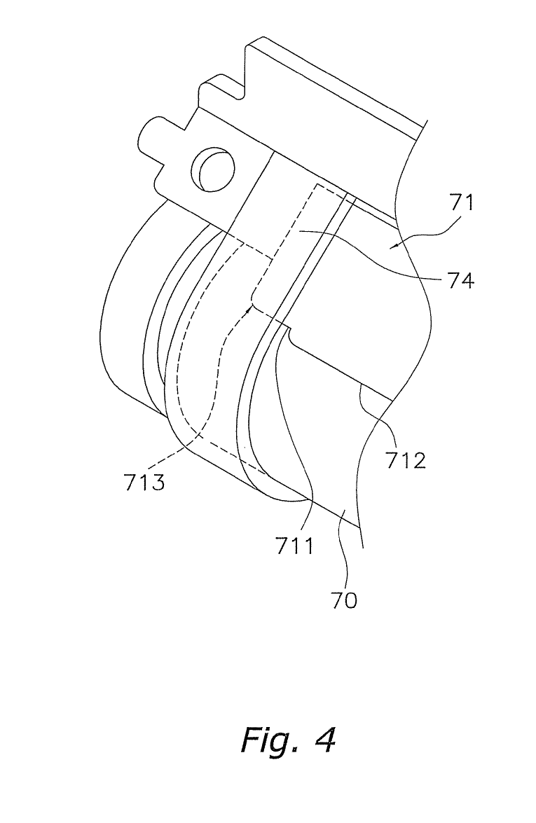

The developing units 16 will be hereinafter explained in detail mainly with reference to FIGS. 3 and 4. FIG. 3 is a cross-sectional view of the developing unit 16. FIG. 4 is a view of a diagram of a developing roller 70 seen from a toner supply roller (toner supplying member) 77. Note that not the entirety of the developing roller 70 but a part thereof is illustrated in FIG. 4. The developing units 16 are formed to have approximately the same configuration. Each of the developing units 16 includes the developing roller 70 functioning as a developer carrier, a toner container 78 having an opening 16a formed along the rotational axis direction of the developing roller 70, a regulating member 71, end-portion sealing parts 74, and a sheet member 75.

The developing roller 70 is provided to supply the photosensitive drum 2 with toner. The toner container 78 has a space for containing toner in its interior. A toner agitating member 76 and a toner supply roller 77 are disposed in the interior of the toner container 78. Also, the developing roller 70 is disposed so that a part of the developing roller 70 is exposed to the outside from the opening 16a formed in the toner container 78.

The regulating member 71 is disposed above the developing roller 70. The regulating member 71 is provided to regulate the amount of toner on the surface of the developing roller 70 so that the thickness of the toner layer formed on the surface of the developing roller 70 is regulated to be a predetermined thickness. The regulating member 71 is a belt-shaped member extending in the axial direction of the developing roller 70. As shown in FIG. 4, its base end side (i.e., upper side illustrated in FIGS. 3 and 4) is fixed to the upper rim portion of the opening 16a formed in the toner container 78 through a support plate. On the other hand, its front end side (i.e., lower side illustrated in FIGS. 3 and 4) is a free or distal end, and a part of the front end side makes contact with the surface of the developing roller 70 and thus they form a nip portion. Also, the regulating member 71 includes a regulating portion 712 that makes contact with an image forming area of the developing roller 70, and end portions 713, both of which make contact with non-image forming areas (i.e., axial end portions of the developing roller 70).

Note that the image forming area of the developing roller 70 is a part of the entire area of the developing roller 70 in the longitudinal (i.e., axial) direction, which is opposed to an area of the photosensitive drum 2 on which an image is formed. On the other hand, the non-image forming areas of the developing roller 70 are parts of the entire area of the developing roller 70 in the longitudinal (i.e., axial) direction, which are opposed to areas of the photosensitive drum 2 on which an image is not formed. Thus the non-image forming areas correspond to areas excluding the image forming area.

As illustrated in FIG. 4, each of the end portions 713 of the regulating member 71 includes a cutout portion 711 in its tip. The protruded amount of the tip edge of the end portion 713 is less than that of the tip edge of the regulating portion 712 because the cutout portion 711 is formed in the end portion 713.

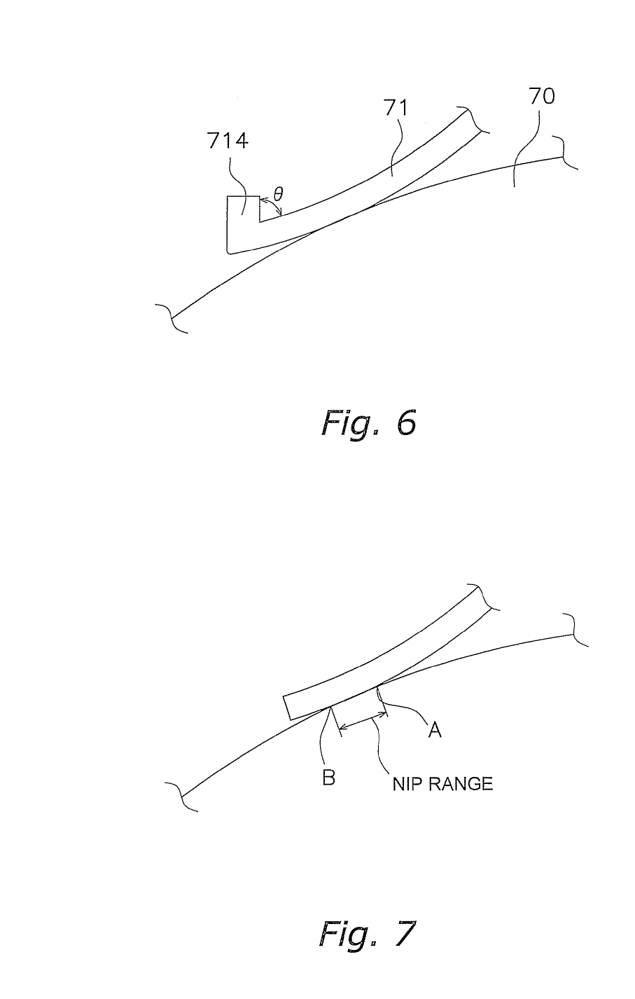

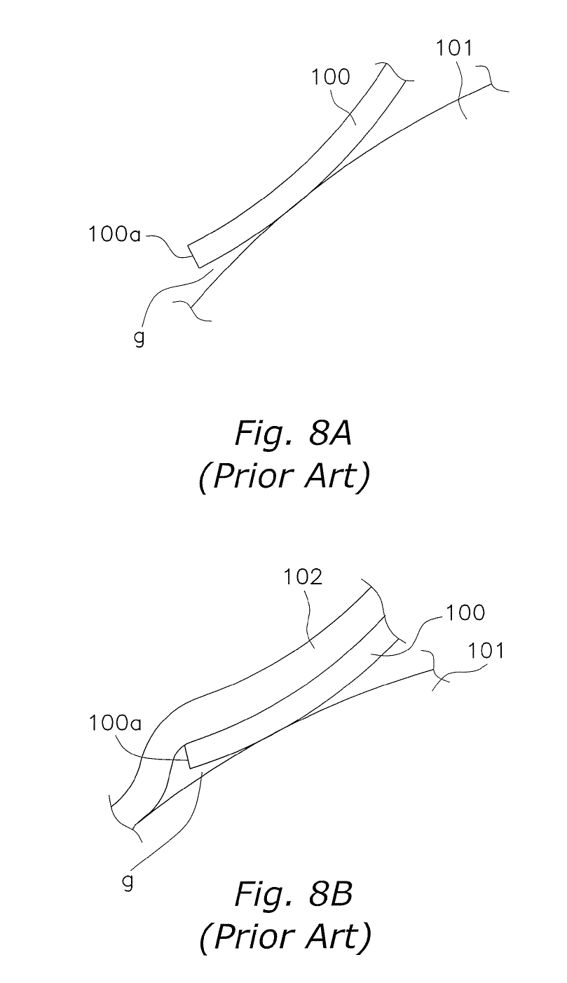

Here, the regulating portion 712, which is a part of the regulating member 71 excluding the longitudinal end portions 713, makes contact with the developing roller 70 in a nip range ranging from “A” to “B” illustrated in FIG. 7, and its tip edge is separated from the developing roller 70. Therefore, a predetermined gap is produced between the tip edge of the regulating portion 712 and the developing roller 70. On the other hand, the tip edges of the end portions 713 in which the cutout portions 711 are respectively formed are positioned in the nip range ranging from A to B illustrated in FIG. 7. In other words, the end portions 713 in which the cutout portions 711 are respectively formed make contact with the surface of the developing roller 70. Here, the symbol A shown in FIG. 7 indicates a position that the regulating member 71 starts making contact with the developing roller 70. On the other hand, the symbol B shown in FIG. 7 indicates a position that the regulating member 71 is separated from the developing roller 70.

Note that the tip edges of the end portions 713 make contact with the surface of the developing roller 70. Therefore, the parts of the surface of the developing roller 70 may be easily damaged by the tip edges. However, in the present embodiment, the tip edge of the regulating portion 712, which makes up the large part of the regulating member 71, is separated from the developing roller 70. Therefore, the posture of the regulating member 71 approximately depends on the regulating portion 712. Accordingly, the press-contacting force applied by the tip edges of the end portions 713 with respect to the surface of the developing roller 70 will also be inhibited. Thus it is possible to reduce the damage on the surface of the developing roller 70 to be caused by the contact with the tip edges.

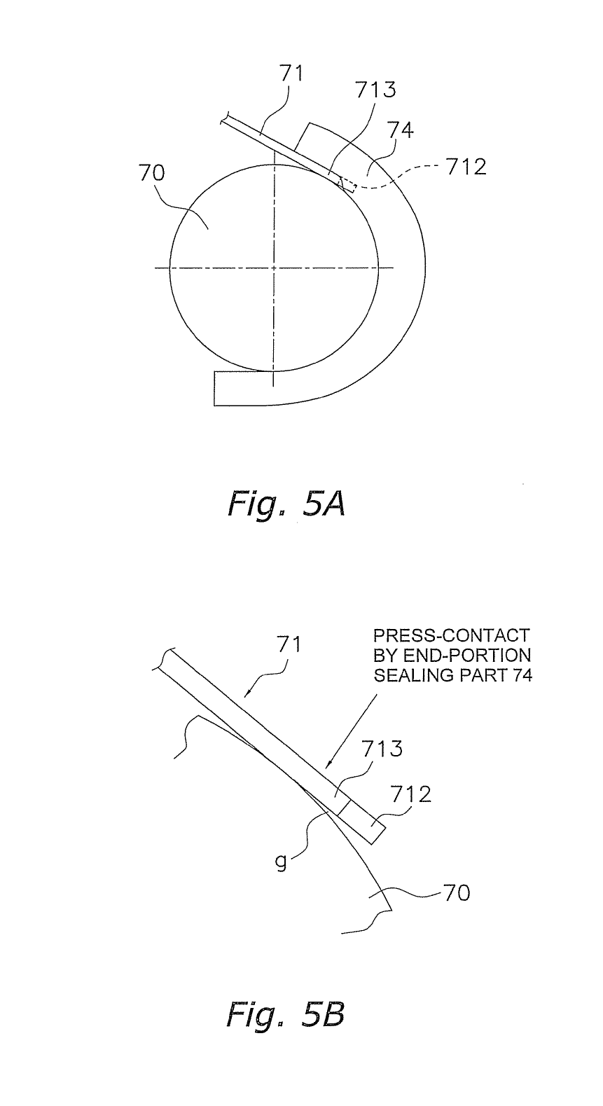

The end-portion sealing parts 74 are disposed on the longitudinal ends of the opening 16a formed in the developing units 16 so as to cover the end portions 713 of the regulating member 71. The end-portion sealing parts 74 are members for preventing toner from leaking from the end portions of the developing roller 70 by making contact with the developing roller 70. Note that the end-portion sealing parts 74 may not cover the entirety of the cutout portions 711 of the end portions 713, and may cover at least the axial ends of the cutout portions 711. Therefore, in the present embodiment, a part of the center area of the cutout portion 711 is not covered with the end-potion sealing part 74. Also, as illustrated in FIG. 5A, the end-portion sealing parts 74 are disposed along the regulating member 71 and the surface of the developing roller 70 so that a gap is not produced between the end portions 713 of the regulating member 71 and the surface of the developing roller 70. In addition, a gap is not produced between the tip sides of the end portions 713 of the regulating member 71 and the end-portion sealing parts 74. Note that FIG. 5A is a diagram of the regulating member 71 and the end-portion sealing part 74 seen from the axial outer side.

Referring to FIG. 3, the sheet member 75 is disposed in the opening 16a formed in the developing unit 16 so as to be opposed to the regulating member 71. The sheet member 75 is provided to prevent toner from leaking by making contact with the developing roller 70. The sheet member 75 is formed in a belt-shape and is extended along the axial direction of the developing roller 70. The toner agitating member 76 is formed by fixing an end of a film-shaped member to a shaft, and its shaft is rotatably supported by the developing unit 16.

### Detailed Explanation of Regulating Member and End-Portion Sealing Part

Arrangement of the regulating member 71, the end-portion sealing parts 74, and the surface of the developing roller 70 will be hereinafter explained in detail.

First, relation between the regulating member 71 and the developing roller 70 will be hereinafter explained with reference to FIGS. 5B and 5C. Note that the relation is based on a state in which the regulating member 71 is not pressed to the developing roller 70 by the end-portion sealing parts 74. As illustrated in FIGS. 5B and 5C, in a state in which the regulating member 71 is not covered with (i.e., pressed by) the end-portion sealing parts 74, the tip edges of the end portions 713 of the regulating member 71 do not make contact with the surface of the developing roller 70. In other words, a slight gap g is produced between the tip edges of the end portions 713 and the surface of the developing roller 70. In FIG. 5C, a hatched portion illustrated with the broken line (i.e., range indicated by the symbol “N”) is the nip range. Therefore, the tip edges of the end portions 713 do not produce the nip range.

In the final assembly state, the end portions 713 of the regulating member 71 are covered with the end-portion sealing parts 74. In FIG. 5C, the end-portion sealing part 74 is illustrated with the double-dashed line. Thus, when the end portions 713 of the regulating member 71 are covered with and pressed by the end-portion sealing parts 74, the end portions 713 of the regulating member 71 are press-contacted with the surface of the developing roller 70. Accordingly, the tip edges of the end portions 713 make contact with the surface of the developing roller 70. In other words, a gap g illustrated in FIG. 5B will not be produced. It should be noted that the tip edge of the regulating portion 712 is kept separated from the surface of the developing roller 70 even when the end portions 713 are covered with the end-portion sealing parts 74.

### Operation

Next, initially referring to FIG. 1, an image forming operation will be hereinafter briefly explained. First, when the color printer is powered on, a variety of parameters are initialized, and a variety of initial settings (e.g., temperature setting of the fixing device 9) will be performed. Then, when the image data are inputted into the printer from a computer connected to the printer or the like and an instruction to start printing is transmitted to the printer, the following image forming operation will be performed. Note that the toner supply pipes 25 are located in the upper retracted position during the image forming operation.

First, the photosensitive drum 2 is electrically charged by the electric-charging roller 10. Then, scanning and exposure, which correspond to the image data, are performed by the laser unit 4 with respect to the photosensitive drum 2, and an electrostatic latent image is formed on the photosensitive drum 2. Next, the rotary developing device 3 is rotated, and accordingly the developing unit 16 of the corresponding color is positioned to be opposed to the photosensitive drum 2. In this state, the electrostatic latent image formed on the photosensitive drum 2 is developed by the corresponding color toner. The developed image is transferred to the intermediate transfer belt 7. A full-color image will be formed on the intermediate transfer belt 7 by sequentially repeating the above described operational steps with respect to each of colors. Note that the residual toner or the like remaining on the photosensitive drum 2 will be cleaned by a drum cleaning device 11, and will be discarded into a waste toner container (not illustrated in the figure).

On the other hand, a sheet of paper is taken out of the paper feeding cassette 52 by a forwarding roller or the like. The sheet of paper is transported in the timing of image formation on the intermediate transfer belt 7, and is guided to the secondary transfer roller 8. The secondary transfer roller 8 makes contact with the intermediate transfer belt 7, and the full-color image formed on the intermediate transfer belt 7 is transferred onto the sheet of paper by way of a transfer bias applied to the secondary transfer roller 8. The sheet of paper is guided to the fixing device 9 via a transporting path, and the image is fixed onto the sheet of paper by way of a heat and pressure applied by the fixing device 9. Then, the sheet of paper is discharged to the discharge part 50.

Next, referring initially to FIG. 3, a series of operations will be hereinafter explained in detail, which includes the operations of supplying toner in the interior of the toner container 78 to the developing roller 70, forming a toner layer on the developing roller 70, and supplying toner to the photosensitive drum 2.

Toner contained in the interior of the toner container 78 is attached to the surface of the toner supply roller 77. The toner supply roller 77 rotates while toner is attached to its surface, and the developing roller 70 rotates along with the toner supply roller 77 in the same direction as the rotation of the toner supply roller 77.

Here, toner on the surface of the toner supply roller 77 is supplied to the developing roller 70, but the sheet member 75, the regulating member 71, and the end-portion sealing parts 74 prevent toner from leaking to the outside from the upper and lower ends of the opening 16a illustrated in FIG. 3. Also, the end-portion sealing parts 74 prevent toner from leaking to the outside from the both axial ends of the developing roller 70 in the opening 16a.

Then, a toner layer with the predetermined thickness is formed on the surface of the developing roller 70 by the regulating member 71 while the developing roller 70 with toner supplied from the toner supply roller 77 on the surface thereof rotates. Specifically, the amount of toner is regulated by the tip of the regulating member 71 and the developing roller 70, and thus a uniform toner layer is formed on the surface of the developing roller 70.

Referring to FIGS. 3 and 4, note that the thickness of a toner layer formed on a part of the developing roller 70, which makes contact with the regulating portion 712 of the regulating member 71, will be greater than that of a toner layer formed on a part of the developing roller 70, which makes contact with the end portions 713. In other words, the tip edges of the end portions 713 of the regulating member 71 make contact with the surface of the developing roller 70. Therefore, the thickness of the toner layer formed thereon will be less than that of the toner layer formed on the other parts of the surface of the developing roller 70 from which the tip edges of the end portions 713 are separated.

As described above, after a toner layer is formed on the developing roller 70, toner is supplied from the developing roller 70 to the photosensitive drum 2.

Here, it is possible to form a toner layer with the thickness necessary for image formation on a part of the developing roller 70 for supplying the photosensitive drum 2 with toner (i.e., the image forming area), and at the same time as this, it is possible to form a toner layer with the thin thickness on areas of the developing roller 70 opposed to the end portions 713, on which an image is not formed. Due to this structure, toner will not be easily accumulated between the end-potion sealing parts 74 and the developing roller 70, and accordingly toner will not easily leak to the outside of the developing unit 16 from the end-portion sealing parts 74. In addition, a gap will not be easily produced between the end-potion sealing parts 74 and the developing roller 70 because the tip edges of the cutout portions 711 are positioned in the nip range. Accordingly, toner will not easily leak to the outside of the developing unit 16 from the parts in which the end-portion sealing parts 74 are disposed.

### Other Embodiments

(a) In the above described embodiment, the image forming device to which toner is supplied from the outside is exemplified. However, an image forming device to which toner is not supplied from the outside may be used in the present invention.

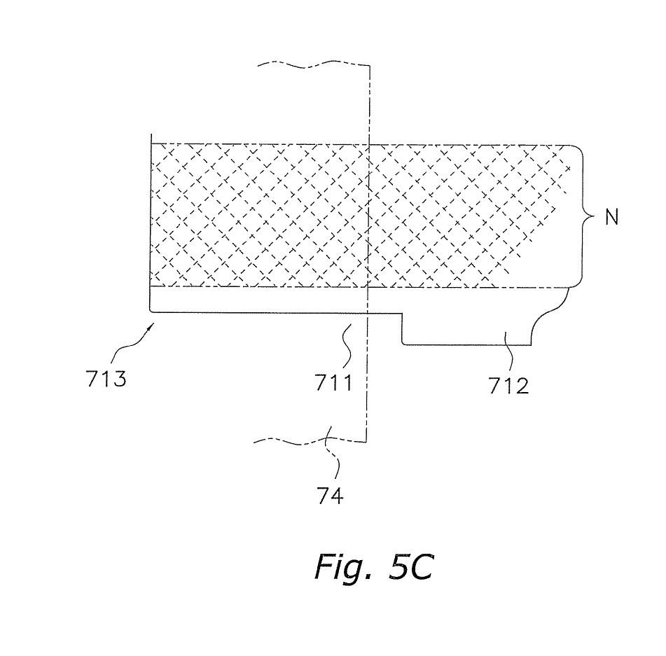

(b) In the above described embodiment, a plate/belt shaped member is used as the regulating member 71. However, the present invention is not limited to this. As illustrated in FIG. 6, a tip 714 of the regulating member 71, which is formed to be perpendicular to the longitudinal direction of the center portion 712 of the regulating member 71, may be bent in a direction separated away from the developing roller 70 on the further tip side than the part of the regulating member 71 which makes contact with the developing roller 70. In this case, it is possible to prevent it from easily being deflected in the longitudinal direction. Also, bending angle θ in FIG. 6 may be set to be acute angle. In this case, compared to a configuration in which the bending angle θ is set to be right angle or obtuse angle, it is possible to more smoothly move the residual toner remaining when the thickness of the toner layer is regulated by the regulating member 71.

### General Interpretation

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A developing device being configured to provide an image carrier with toner, comprising:
a toner container being disposed to be adjacent to the image carrier, the toner container having an opening on a side opposite the image carrier, the toner container being configured to contain toner in its interior;
a developer carrier being rotatably supported by the toner container, a part of the developer carrier being exposed to the outside of the toner container from the opening formed in the toner container, the developer carrier being configured to provide the image carrier with toner;
end-portion sealing parts being disposed in the axial end portions of the opening formed in the toner container, the end-portion sealing parts being configured to prevent toner leaking from the toner container; and
a regulating member being configured to regulate the amount of toner on the surface of the developer carrier while the tip side of the regulating member makes contact with the surface of the developer carrier, tip edges of axial end portions of the regulating member making contact with the surface of the developer carrier while the axial end portions are pressed to the surface of the developer carrier by the end-portion sealing parts.

2. The developing device of claim 1, wherein
the regulating member includes a regulating portion and the axial end portions, a tip of the regulating portion makes contact with the surface of the developer carrier opposed to an image forming area of the image carrier, the end portions are formed at both axial ends of the regulating portion, and tip edges of the end portions make contact with the surface of the developer carrier opposed to a non-image forming area of the image carrier.

3. The developing device of claim 2, wherein
a part of the tip of the regulating portion of the regulating member excluding the tip edge of the tip makes contact with the surface of the developer carrier, and the tip edge is separated from the surface of the developer carrier.

4. The developing device of claim 2, wherein the end-portion sealing parts cover at least axially outer end edges of the end portions of the regulating member from the outer peripheral side.

5. The developing device of claim 2, wherein
each of the end portions of the regulating member includes a cutout, and the amount of protrusion of the tips of the end portions in a circumferential direction of the developer carrier is less than the amount of protrusion of the regulating portion.

6. The developing device of claim 2, wherein
the tip of the regulating portion of the regulating member is bent in a direction separated away from the surface of the developer carrier so that the distance between the tip of the regulating portion and the surface of the developer carrier is increased toward the apex of the tip.

7. The developing device of claim 1, further comprising
a toner agitating member being configured to agitate the toner in the interior of the toner container.

8. The developing device of claim 1, wherein
the toner container further includes a toner supplying member in the interior thereof, and the toner supplying member is configured to supply the developing roller with toner.

9. An image forming device, comprising:
an image carrier being configured to have an electrostatic latent image formed on a surface thereof;
a developing device being configured to form a toner image on the image carrier by supplying the image carrier with toner;
a paper supplying part being configured to supply a sheet of paper;
a transfer part being configured to transfer the toner image formed on the image carrier onto the sheet of paper; and
a fixing device being configured to fix the toner image transferred onto the sheet of paper, and
the developing device including
a toner container being disposed to be adjacent to the image carrier, the toner container having an opening on a side opposite the image carrier, the toner container being configured to contain toner in its interior, a developer carrier being rotatably supported by the toner container, a part of the developer carrier being exposed to the outside of the toner container from the opening formed in the toner container, the developer carrier being configured to provide the image carrier with toner,
end-portion sealing parts being disposed in the axial end portions of the opening formed in the toner container, the end-portion sealing parts being configured to prevent toner leaking from the toner container, and
a regulating member being configured to regulate the amount of toner on the surface of the developer carrier while the tip side of the regulating member makes contact with the surface of the developer carrier, tip edges of axial end portions of the regulating member making contact with the surface of the developer carrier while the axial end portions are pressed to the surface of the developer carrier by the end-portion sealing parts.
